(19) United States
(12) Patent Application Publication
(10) Pub. No.: US 2018/0332774 A1
(43) Pub. Date: Nov. 22, 2018

(54) GARDEN PLANTER

(71) Applicant: AUSTIN LOTT, BURLEY, ID (US)

(72) Inventor: AUSTIN LOTT, BURLEY, ID (US)

(21) Appl. No.: 15/984,209

(22) Filed: May 18, 2018

Related U.S. Application Data
(60) Provisional application No. 62/508,131, filed on May 18, 2017.

(51) Int. Cl. A01G 9/02; A01G 9/24; A01G 9/20; A01G 9/26

(52) U.S. Cl. CPC A01G 9/023; A01G 9/26; A01G 9/20; A01G 9/247

(57) ABSTRACT

A space saving planter for use in gardening. The garden planter which is comprised of vertical supports and shelves, is collapsible and allows a gardener to maximize his or her growing area in small spaces such as patios by offering a large garden surface area in a vertical arrangement proportional in surface area to typical horizontal space requirements of a standard garden.

### PRIORITY/CROSS-REFERENCE TO RELATED APPLICATIONS

This application claims the benefit of U.S. Provisional Application No. 62/508,131 filed May 18, 2017, the disclosure of which is incorporated by reference.

### TECHNICAL FIELD

The presently disclosed technology relates to garden planter structures, and more particularly to garden planters with vertical structures.

### BACKGROUND

This invention is a garden planter structure for use in gardening. Gardening is becoming a very popular hobby in urban, suburban, and rural settings. However, people living in urban or suburban environments often lack the available space to grow anything more than a few small potted plants or utilize a small garden box. Utilizing these small planting methods can make it difficult to grow root vegetables or more that but a few varieties of fruiting or leafy vegetables.

The disclosed invention is designed to give people the ability to grow their own nutritious foods and beautiful flowers whether they live on a farm or in a high rise apartment in a metropolitan city environment by providing a vertically oriented growing planter that provides for a sufficient root growth zone to grow root vegetables. The disclosed inventive concepts can accommodate flowers, leaf vegetables such as lettuces, fruiting vegetables such as peppers and eggplant, and root crops such as potatoes, carrots, leeks, radishes, beets, and more.

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

What is disclosed is a planter that allows people to grow a variety of vegetables without requiring a traditional ground garden. The planter allows for a large garden surface area in proportion to the overall horizontal space requirement of the garden. This allows a gardener to maximize his or her growing area in a small space such as on a patio. The user is able to increase the overall gardening square footage while minimizing the overall footprint of the garden. The planter provides sufficient area for the roots of rooting vegetables to grow while also facilitating the growth of fruiting vegetables, leafy vegetables, and herbs.

In the first embodiment, the planter is in the form generally of a cube or box. In a preferred embodiment, the cube model has measurements of 33 inches wide, 32 inches tall, and 33 inches deep. Included on the cube model are 22 inch growing sections, which give for over 36 feet of growing space and a nearly 4 square foot growing space on top of the cube or box to accommodate larger plants such as tomatoes, cucumbers, peppers, and squash.

The cube embodiment includes a soil space saver cube, which greatly reduces the quantity of soil needed. The soil space saver cube is a second cube that fits within the first cube to occupy space such that the amount of soil needed is reduced. The internal cube can also include functionality to accommodate accessories. These accessories can include accessories that are intended to extend the growing season. For example, the cube can include a mounting system to accommodate electro thermostatic controlled heating element. The external cube can be configured to accommodate further accessories such as a rain cover, a shade cover, and/or a cold weather greenhouse cover. This system can include mounts for mounting an irrigation system, such as a drip line system. The devices can be made mobile with wheels attached to the drip pan of each planter. These wheels can include caster wheel assemblies. The drip pan can further be configured with a drainage hole and utilize a plug to plug the drainage hole.

In the preferred embodiment the invention includes a sliding channel such that caster wheels can be inserted into the bottom of the drip pan. In further embodiments, the inventive concepts are found in a space saver model. The space saver model includes a smaller drip pan and features in sum only one side of the cube. This space saver model can be made in a variety of vertical heights. The space saver model is ideally placed against a wall to provide additional support. For example, the space saver model can be made in an embodiment that is 24 inches wide, 54 inches tall and 8 inches deep. This space saver embodiment includes a drip pan that is generally 13 inches wide, 24 inches in length, and 2 inches deep. In a preferred embodiment the drain pans in any of the embodiments can include a drainage hole and plug for draining excess liquid in the drip pan.

In a further preferred embodiment the space saver module can be provided in a modular format. The module includes a drip pan that is preferable provided in a flat orientation. The flat orientation is configured such that a consumer can bend the flat orientation to form a drip pan. The drip pan includes locking tabs to facilitate the maintenance of a the drip pan shape. In a preferred embodiment the flat orientation is a flat piece of metal, such as sheet metal, that is creased or pre-bent in order to facilitate a consumer shaping the drip pan.

In a preferred embodiment the modular unit includes a vertical section, which above is described as a side of a cube. The vertical second in a preferred embodiment includes two side pieces, a back piece, two stabilizer feet which can be integral with or attachable to the side pieces to provide support when the vertical section is placed within the drip pan. The vertical section includes generally two cross stabilizers that span the opening in the front of the vertical section. Alternatively one or more stabilizers could be used. The stabilizers are provided for lateral stability of the unit.

In a preferred embodiment the modular unit is provided to a consumer as all flat, or nearly flat, pieces to facilitate shipping. These side pieces and the back piece connect to proved the structure of the vertical section. In a preferred embodiment the connection is by a tab and groove or opening format, such that the tab of one piece fits into the grove of a second piece.

The modular unit can be extended vertically by adding a subsequent vertical unit on top of the first vertical unit. In a preferred embodiment his occurs via the method of adding a back section to the top of the first back section. The two stacked back sections interlock by a series of tabs on the second back section that are placed on the top of the first back section in an alternating fashion. Two opposing sides are added and connected to the back section by a tab and slot mechanism. In a preferred embodiment the sides utilize tabs that are placed on alternating sides of the two lower sides. Horizontal stabilizer pieces are added to stabilize the front of the vertical section. Shelves can then be added to the modular unit to stabilize soil or dirt and facilitate the planting of plants.

In a preferred embodiment a method is disclosed of assembling a

It is preferred that all of the embodiments are made in an easily assembled and disassembled manner. Each of the models is designed to be shipped in a flat shipping container and assembled easily by a user.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 is a perspective view of an embodiment of the inventive concepts.

FIG. 2 is a perspective view of an embodiment of the inventive concepts.

FIG. 3 is a perspective view of an embodiment of the inventive concepts.

FIG. 4 is a perspective view of an embodiment of the inventive concepts.

FIG. 5 is a perspective view of an embodiment of the inventive concepts.

FIG. 6.1 is a view of a section of a cube of an embodiment of the inventive concepts.

FIG. 6.2 is a perspective view of a cube of an embodiment of the inventive concepts.

FIG. 6.3 is a bottom view of a drip pan embodiment.

FIG. 6.4 is a perspective view of an embodiment of a cube on a drip pan embodiment.

FIG. 6.5 is a perspective view of an embodiment of a tab and slot mechanism of the presently disclosed inventive concepts.

FIG. 6.6 is a perspective view of a step in the assembly of an embodiment of the presently disclosed inventive concepts.

FIG. 6.7 is a perspective view of a step in the assembly of an embodiment of the presently disclosed inventive concepts.

FIG. 7 is an alternative embodiment of the presently disclosed inventive concepts.

FIG. 8 is an alternative embodiment of the presently disclosed inventive concepts.

FIG. 9 is an alternative embodiment of the presently disclosed inventive concepts.

FIG. 10.1 is a perspective view of a step in the assembly of an embodiment of the presently disclosed inventive concepts.

FIG. 10.2 is a perspective view of a step in the assembly of an embodiment of the presently disclosed inventive concepts.

FIG. 10.3 is a perspective view of a step in the assembly of an embodiment of the presently disclosed inventive concepts.

FIG. 10.4 is a perspective view of a step in the assembly of an embodiment of the presently disclosed inventive concepts.

FIG. 10.5 is a perspective view of a step in the assembly of an embodiment of the presently disclosed inventive concepts.

FIG. 11 is a perspective inside view of an embodiment of a corner of a drip pan.

FIG. 12 is a is a top view of an embodiment of a corner of a drip pan.

FIG. 13 is a perspective outer view of an embodiment of a corner of a drip pan.

FIG. 14 is a perspective view of a step in the assembly of an embodiment of the presently disclosed inventive concepts.

FIG. 15 is a perspective view of a step in the assembly of an embodiment of the presently disclosed inventive concepts.

FIG. 16 is a perspective view of a step in the assembly of an embodiment of the presently disclosed inventive concepts.

FIG. 17 is a perspective view of a step in the assembly of an embodiment of the presently disclosed inventive concepts.

FIG. 18 is a perspective view of a step in the assembly of an embodiment of the presently disclosed inventive concepts.

FIG. 19 is a perspective view of a step in the assembly of an embodiment of the presently disclosed inventive concepts.

FIG. 20 is a perspective view of a step in the assembly of an embodiment of the presently disclosed inventive concepts.

FIG. 21 is a perspective view of a step in the assembly of an embodiment of the presently disclosed inventive concepts.

FIG. 22 is a perspective view of a step in the assembly of an embodiment of the presently disclosed inventive concepts.

FIG. 23 is a perspective view of a step in the assembly of an embodiment of the presently disclosed inventive concepts.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

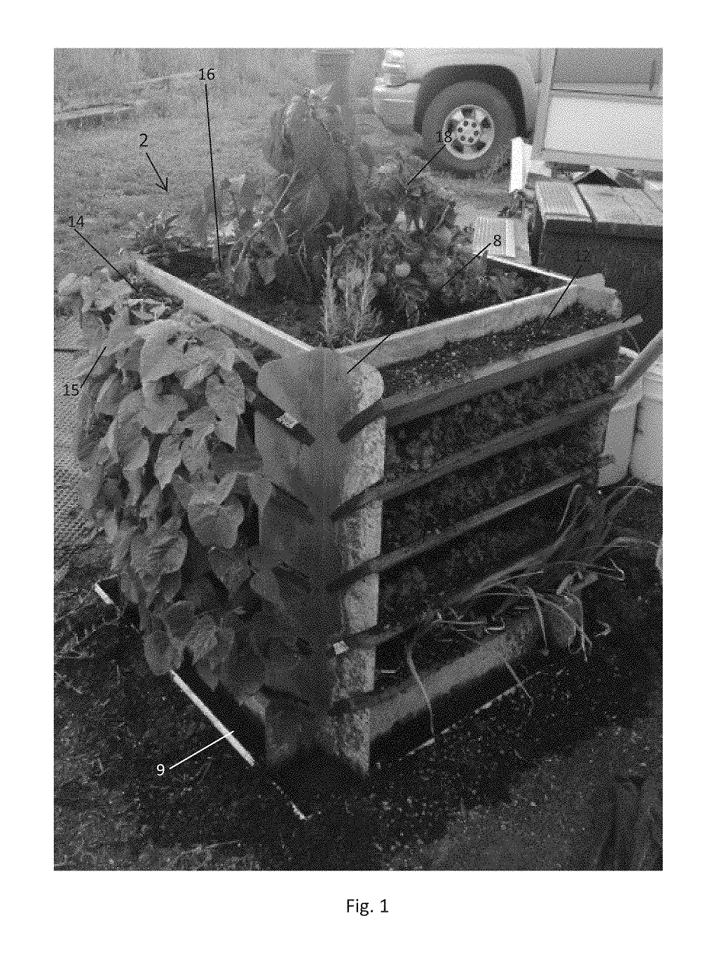

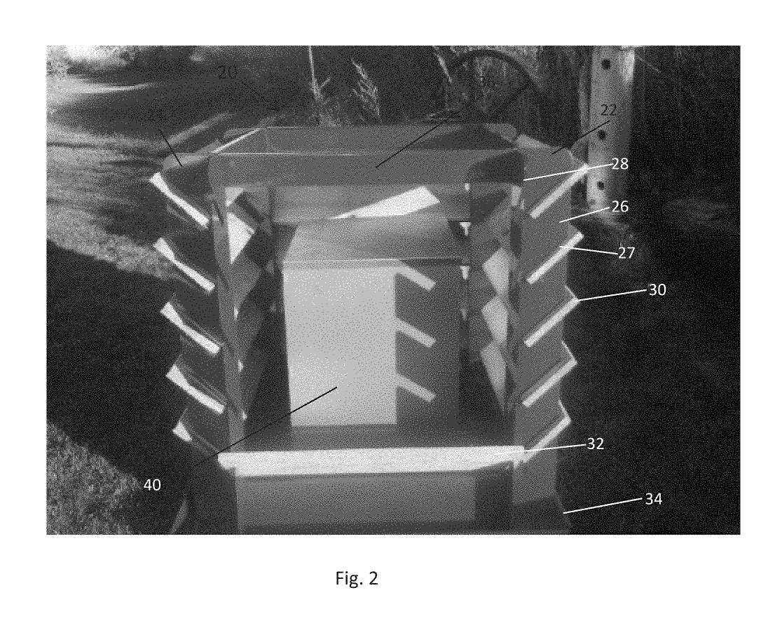

FIG. 1 illustrates an embodiment of the invention in a cube or box form 2. The cube or box is comprised of corners 8 that are connected by angled shelves 6 that fit into slots on each of the corners. The shelves are constructed to be removable after assembly. In a preferred embodiment the shelves 6 are constructed of wood, although a variety of materials can be used. The top of the box is open and receives soil when the box is being filled. Plants planted in the top of the box 16 can include a variety of larger or longer rooted plants 18 that can stretch downward into the box. Along the sides of the box, soil is held in place by each of the shelves 6. The pockets 14 on the side created by the soil in conjunction with the cross board 6 are facilitative of growing typically smaller vegetables or smaller rooted vegetables 15. A drip pan 9 provides a base onto which the corners are positioned during the assembly. The drip pan facilitates reception of water or other liquid that drains through the soil. FIGS. 2 through 5 illustrate the embodiment of FIG. 1 in a state in which the cube or box has not been filled with soil or other plant growth medium. The depicted wooden shelves of the planter are positioned in slots or channels of each of the corner pieces. In the depicted embodiment the corner pieces of the invention are supported and held together by an upper cross support member and a lower cross support member. The corners and cross support members are constructed in a preferred embodiment such that the pieces interlock without the need for any additional connecting hardware.

FIG. 2 illustrates a partially assembled gardening cube 20 having internal box 40 positioned on a drip pan 34. Wood shelves 30, 32 are placed as to span between adjacent corners 22, 24. The wood shelves are generally positioned in angled slots in the vertical cross units. The corners are held in an upright position by an upper 36 and a lower cross stabilizing member. Soil or other plant growth medium is typically poured in from the top of the box to fill the cavity between the internal box or cube and the external box or cube structure. The internal box or cube serves to occupy space such that the planter requires less plant growth medium as well as to provide a mounting surface for optional heating elements. As the soil is poured in, the wood shelves retain the soil in place while providing for a shelf like growing section.

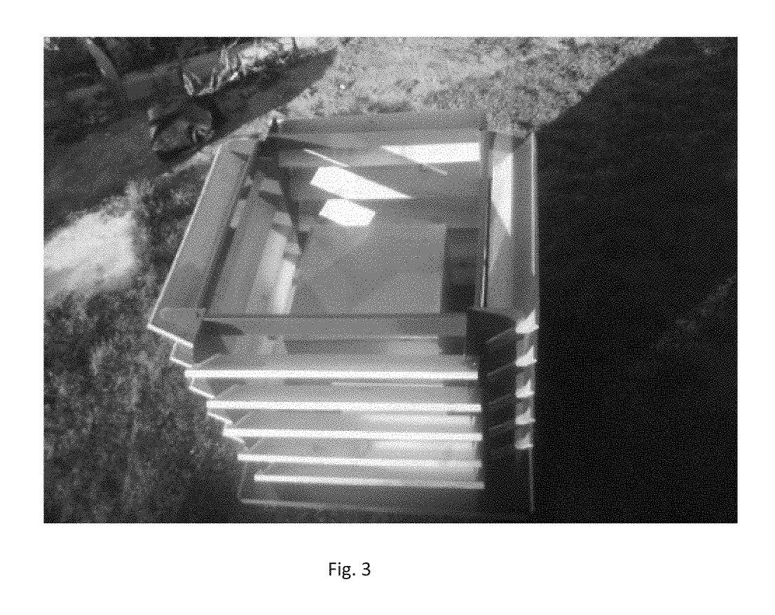

FIG. 3 illustrates a top perspective view of a fully assembled cube or box planter. As discussed above, the internal box provides both a soil reducing function as well as providing a structure onto which a heating element can be placed to provide heat to the planter when used in colder climates or in early planting season use.

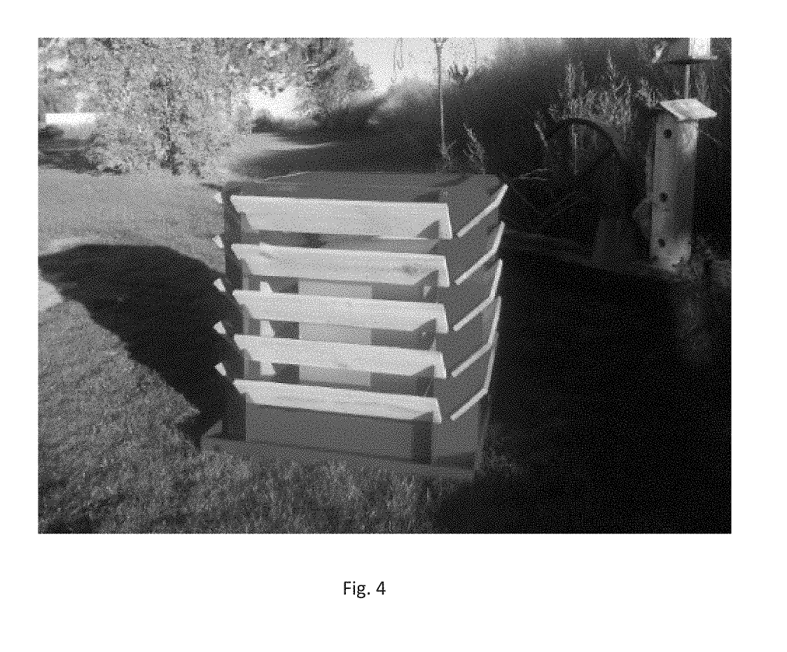

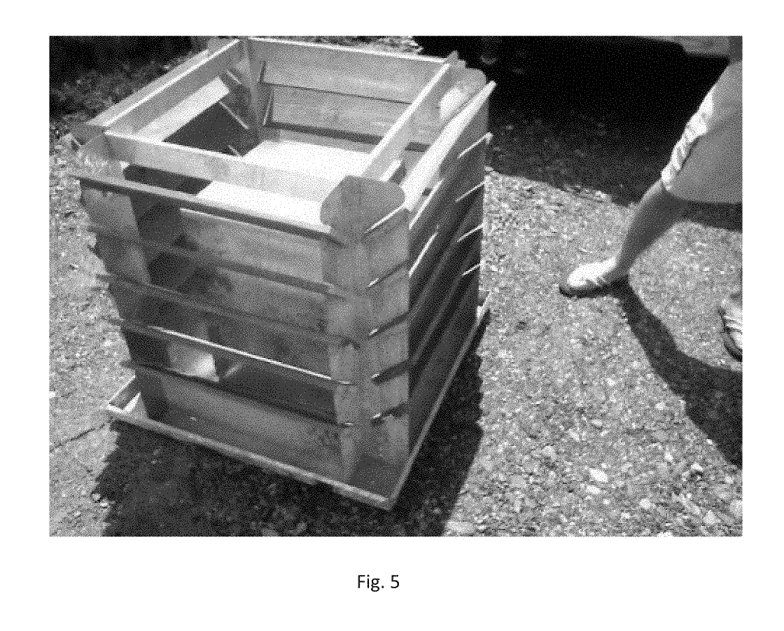

FIG. 4 is a side perspective view showing a box or cube planter in a fully assembled form. The depicted wooden shelves extend between adjacent corners at approximately a 45 degree angle from the vertical corners, thus providing a retention mechanism for soil placed within the planter as well as to provide shelves of soil for plant propagation. Although the depicted angle is thought to be preferred, any angle can suffice that allows soil or other plant growth medium to be retained within the cube.

In a preferred embodiment the unit is shipped in a flat pack configuration without the shelves in order to save weight and shipping cost allowing the user can obtain the shelving material from a local building or hardware supply store. In a preferred embodiment the wooden shelves are made from cutting a cedar ⅝×6, such as that typically utilized in fencing applications, into smaller subsections of the appropriate size to span between two adjacent corners. Alternatively the wooden shelves can be shipped with each unit such that the consumer is not required to cut the shelves.

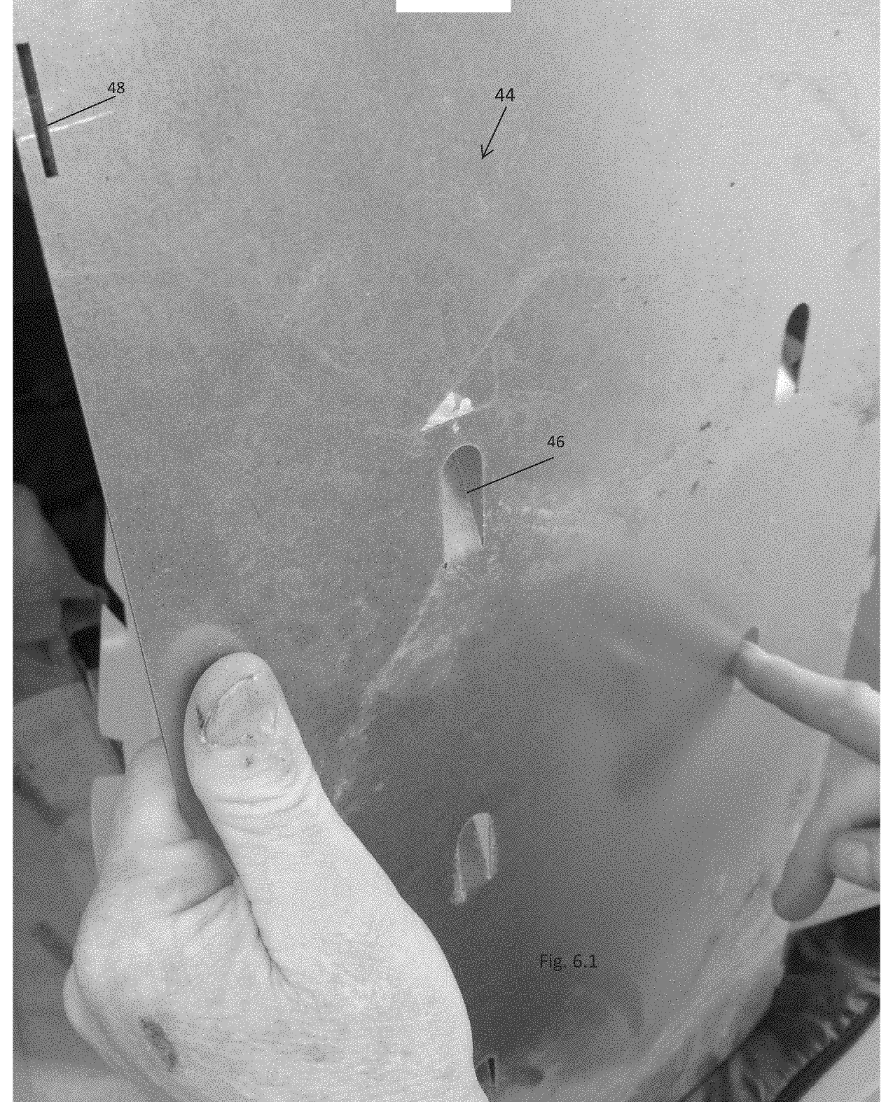

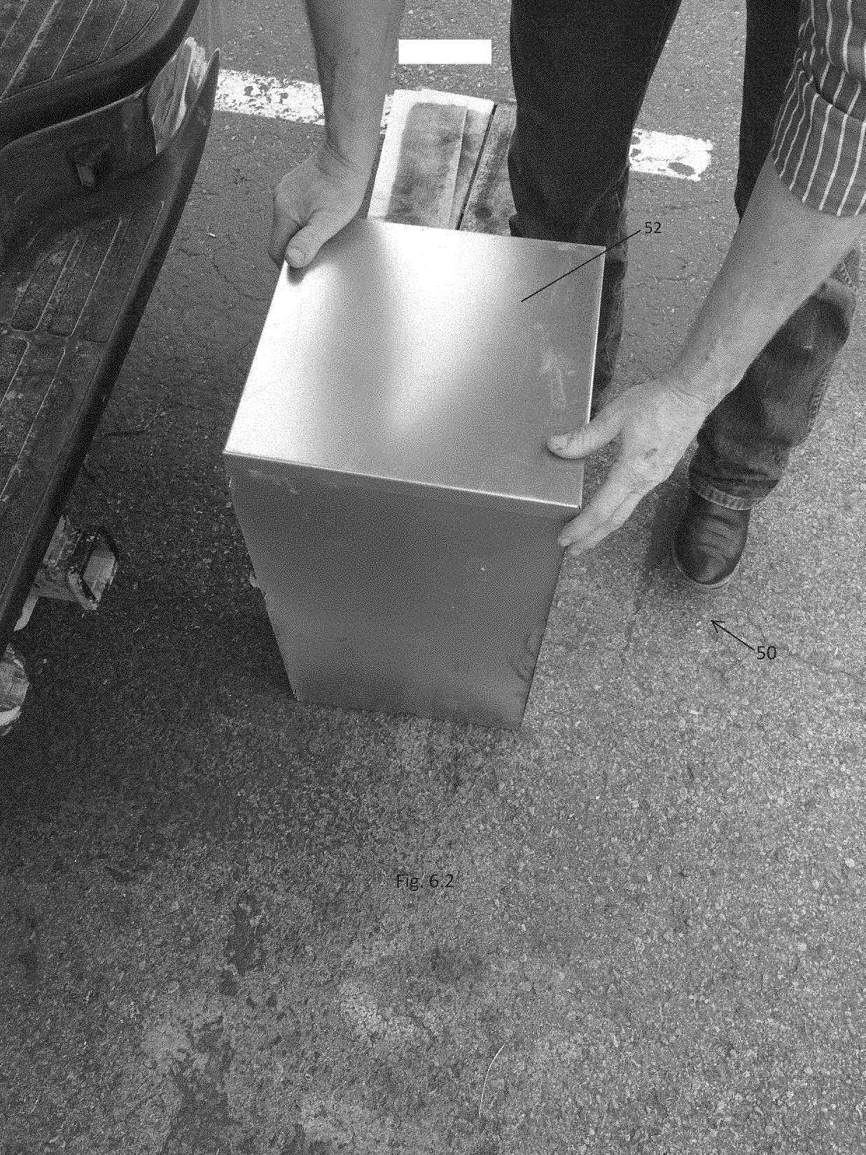

FIG. 5 is a top perspective view of an embodiment of a garden planter. Figure five illustrates four corners arranged in a box or cube like structure connected by upper and lower horizontal support pieces.

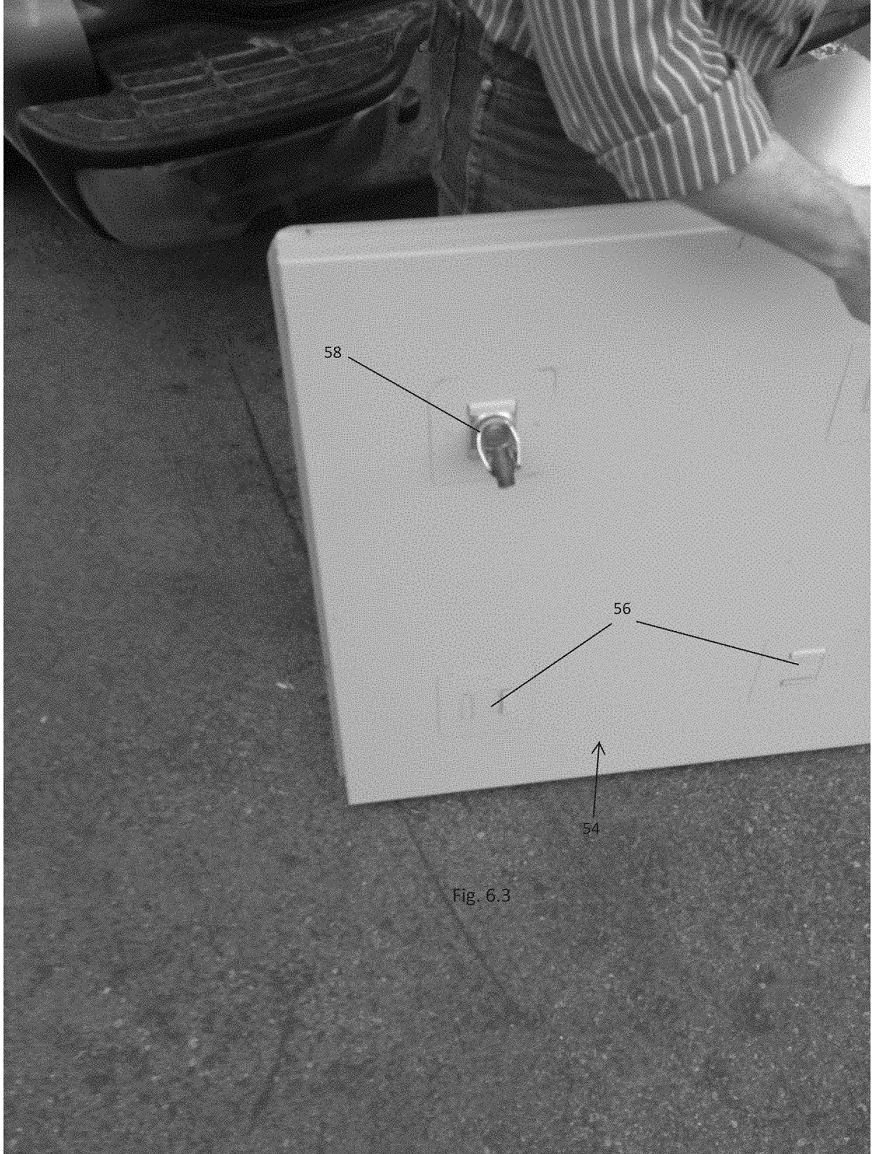

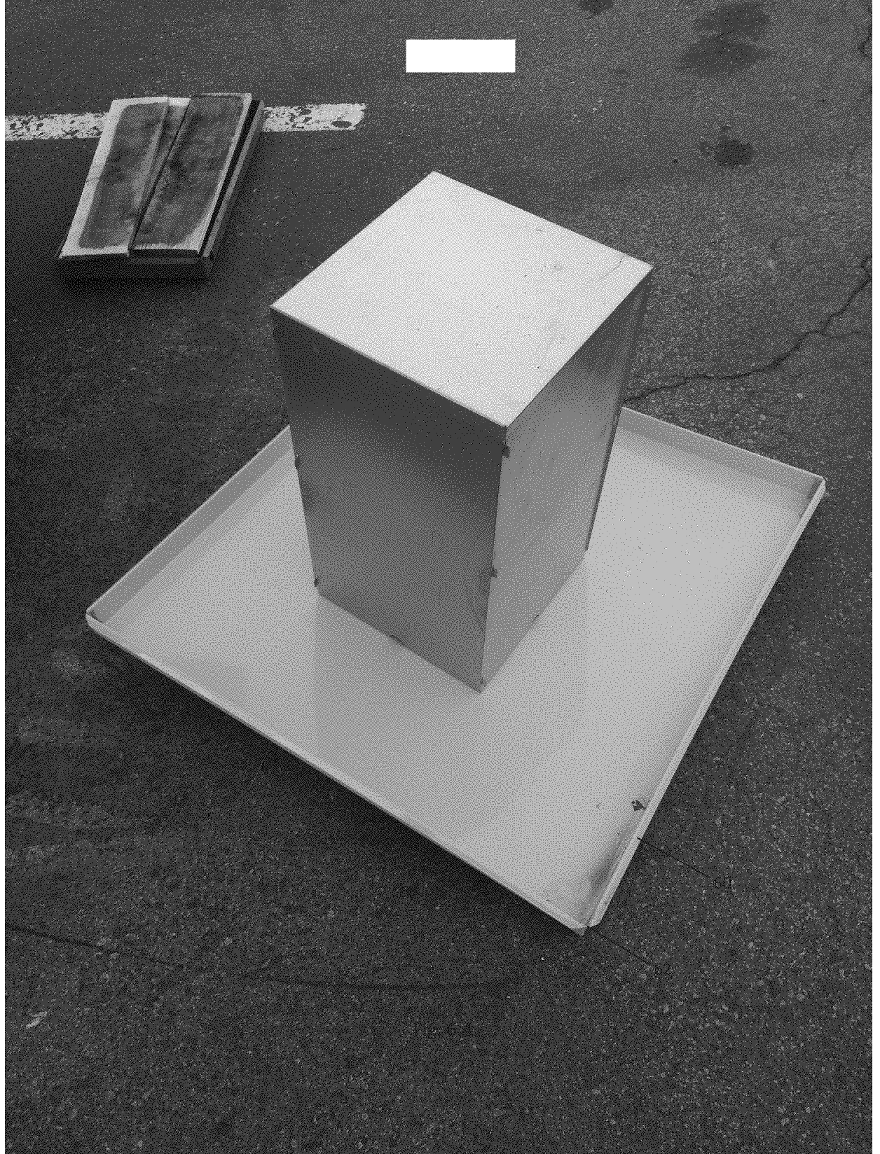

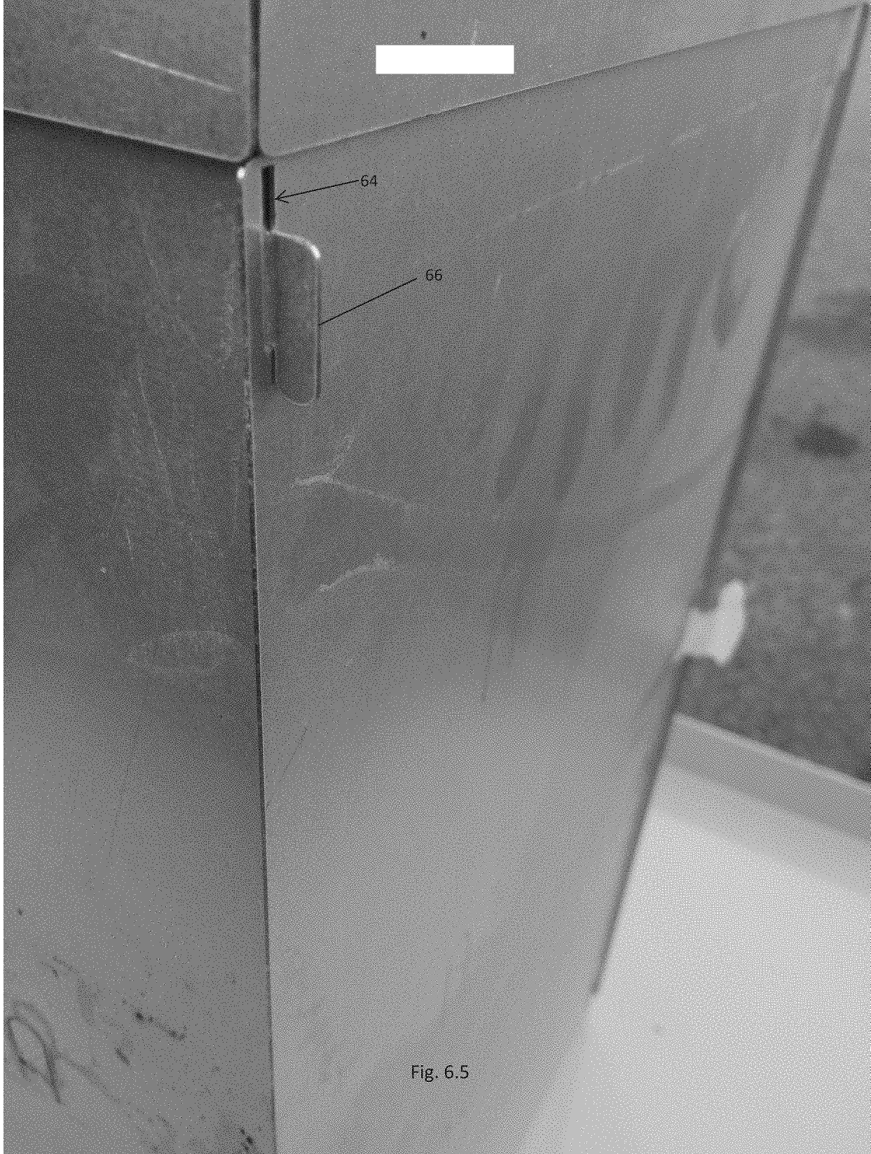

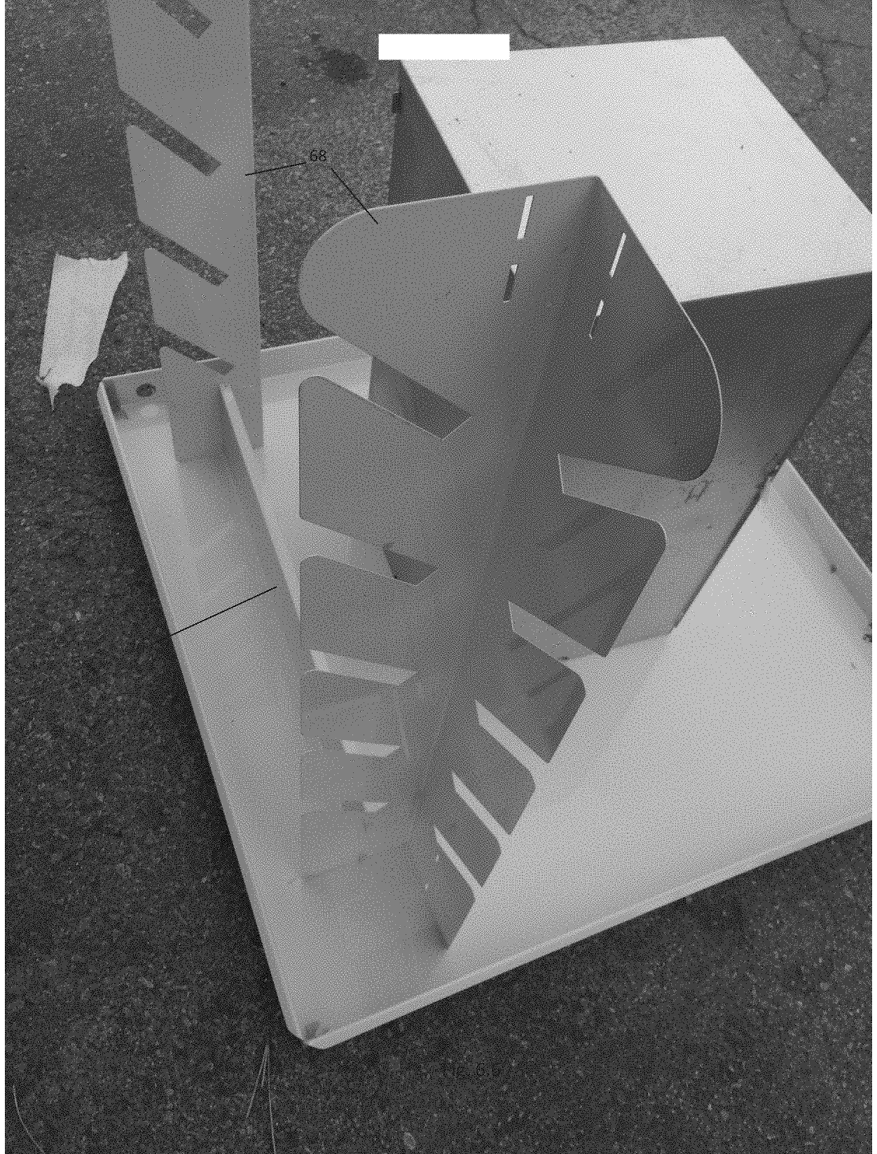

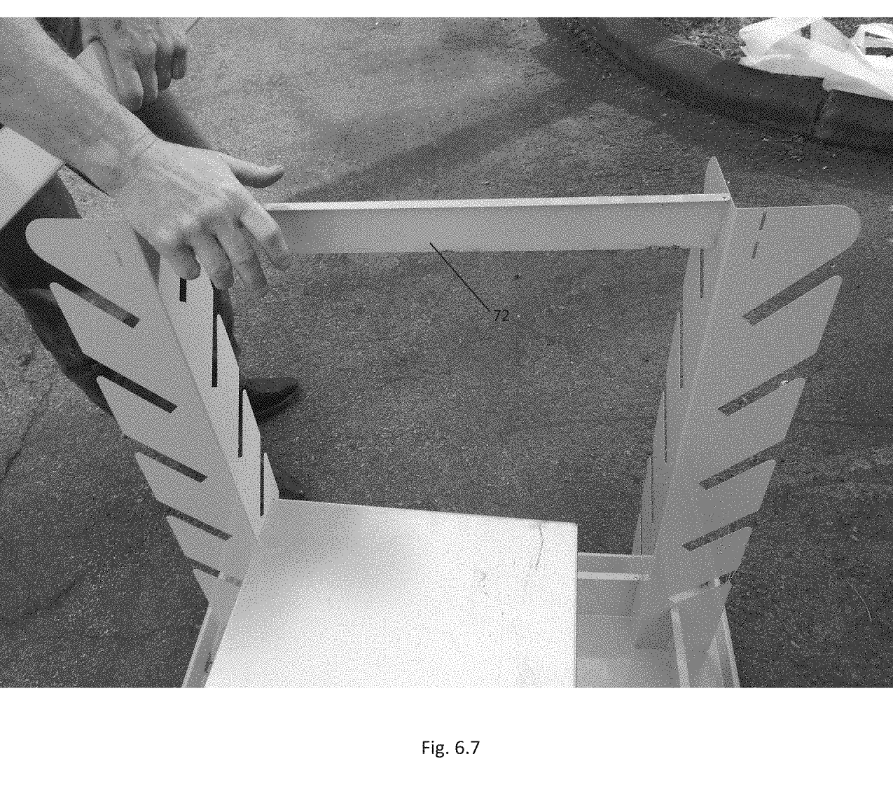

FIG. 6.1 illustrates a first side 44 of an internal box or cube. The sides of the internal box can include partial cutouts 46 that can be pushed through by a user to provide a mounting system for an optional heating element. The sides of the internal box are connected via a series of connectors 48 integral with and located at the corners of each of the sides of the box. Generally the connectors include a female opening on a first side of the box and a male interlocking connector on the edge of the second side of the box. While an interlocking joint is a preferred connection mechanism, separate connectors can conceivably work in the invention.

The internal box also includes a top as illustrated in FIG. 6.2. A first side of the internal box is show. When assembled, the internal box 50 has four sides and a top 52.

FIG. 6.3 illustrates a bottom view of a drip pan. The drip pan 54 in the depicted embodiment has four channels 56 into which caster wheels 58 can be positioned. The drip pan is typically shipped in a flat configuration in conformance with the flat pack shipping structure of the remainder of the planter.

FIG. 6.4 illustrates the top of the drip pan. The edges of the drip pan have pre-formed bends or creases such that the edges can be bent upwards to form the lip of the drip pan. In a preferred embodiment the drip pan lip 60 is generally 2 inches in depth. The corners 62 of the folded portion of the lip generally have a retaining mechanism such that the corners are held together after they have been folded upwards. The internal box 50, once assembled, can then be placed into the drip pan. Alternatively the internal box can be assembled on the drip pan.

FIG. 6.5 illustrates the mechanism by which the sides of the internal box interlock together. One of the sides features a female opening 64 into which a male portion 66 of a corresponding side panel is inserted. A variety of connector mechanisms can be utilized to attach the corners of the internal box together.

FIG. 6.6 illustrates the assembly of two corner sections 68 of the external box or cube. The corner sections are placed in corner locations for the external box or cube and a lower cross support member 70 is attached to the corner members. This provides support to the corner members. An upper horizontal support member 72 is added as shown in FIG. 6.7. Horizontal angled wood shelves are inserted into the grooves in each of the sides of the external box. Subsequently soil or other plant growth medium is input into the external box typically from above in the open ended top of the external box.

FIG. 7 illustrates a second embodiment 80 of a planter utilizing in essence a single side of the box in an orientation. A drip pan 82 is provided on which a vertical planting shelf rests. As depicted in the embodiment of FIG. 1, the planting structure utilizes a series of shelves 84 spanning between two side vertical support sections 86, 88, analogous to the function of the corner units in FIG. 1. The side vertical support sections 86, 88 can be formed as a single piece interconnected with a back section and folded or bent into place. Alternatively the vertical support sections can be provided as separate sections and connected to the back section. In a preferred embodiment the shelves 84 are wooden ⅝×6's that are cut to length, although the device can be constructed with other dimensions consistent with the spirit of the invention disclosed herein. Preferably these pieces are a cedar or a similarly resistant material that is preferably free of any type of chemical to avoid any chemical leaching into the soil into which the plants are planted.

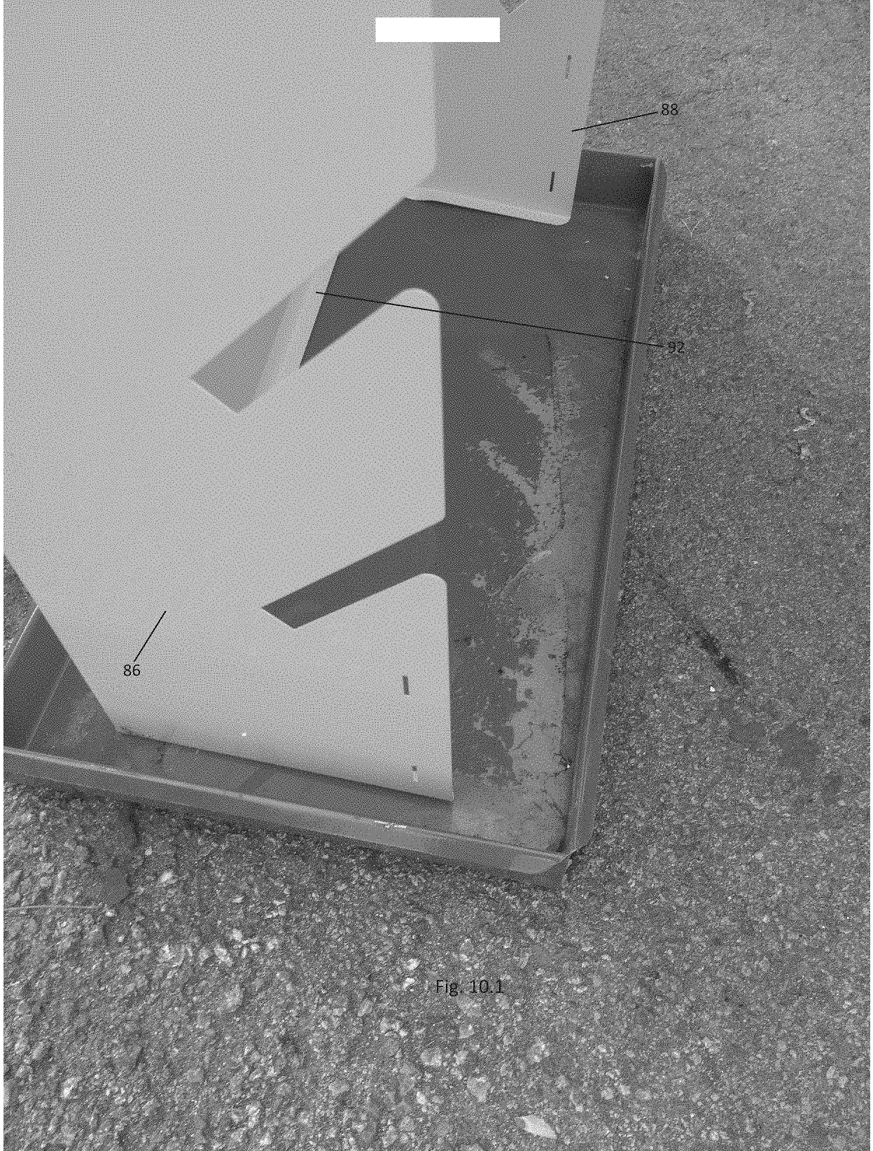

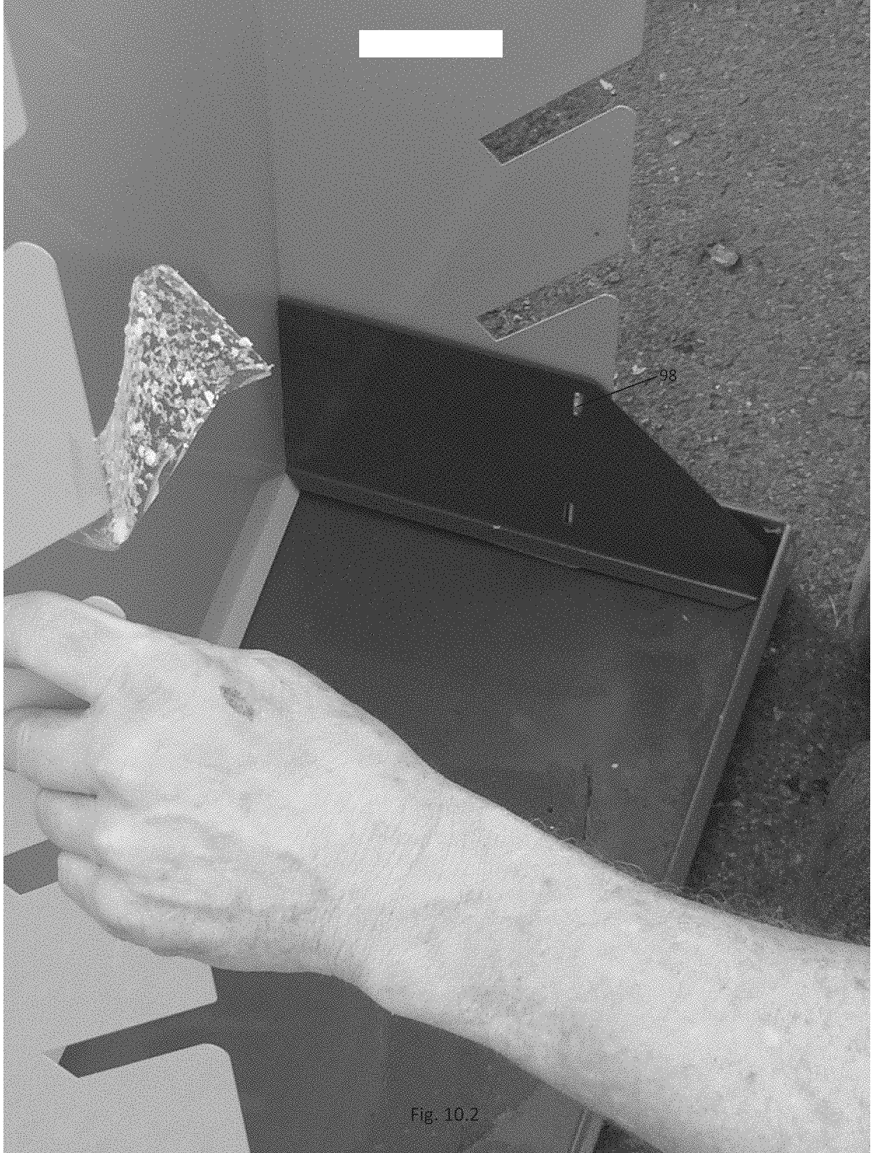

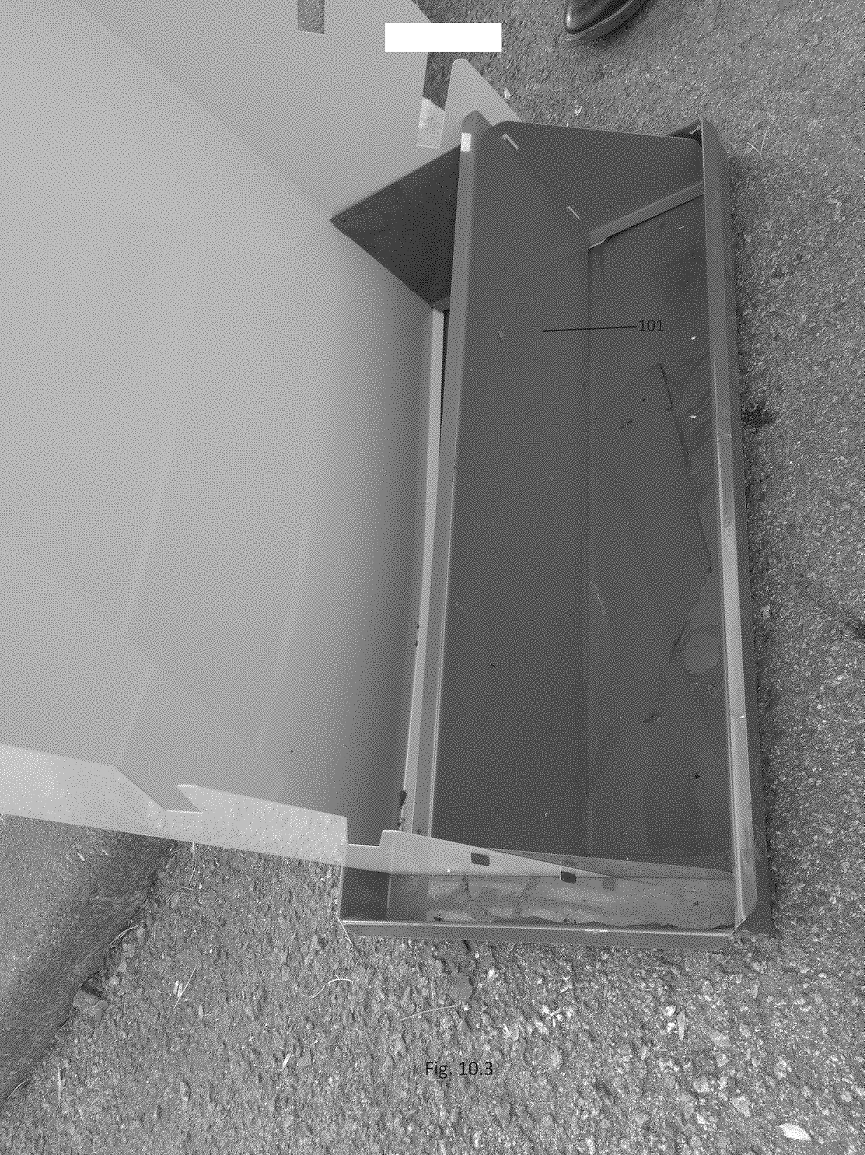

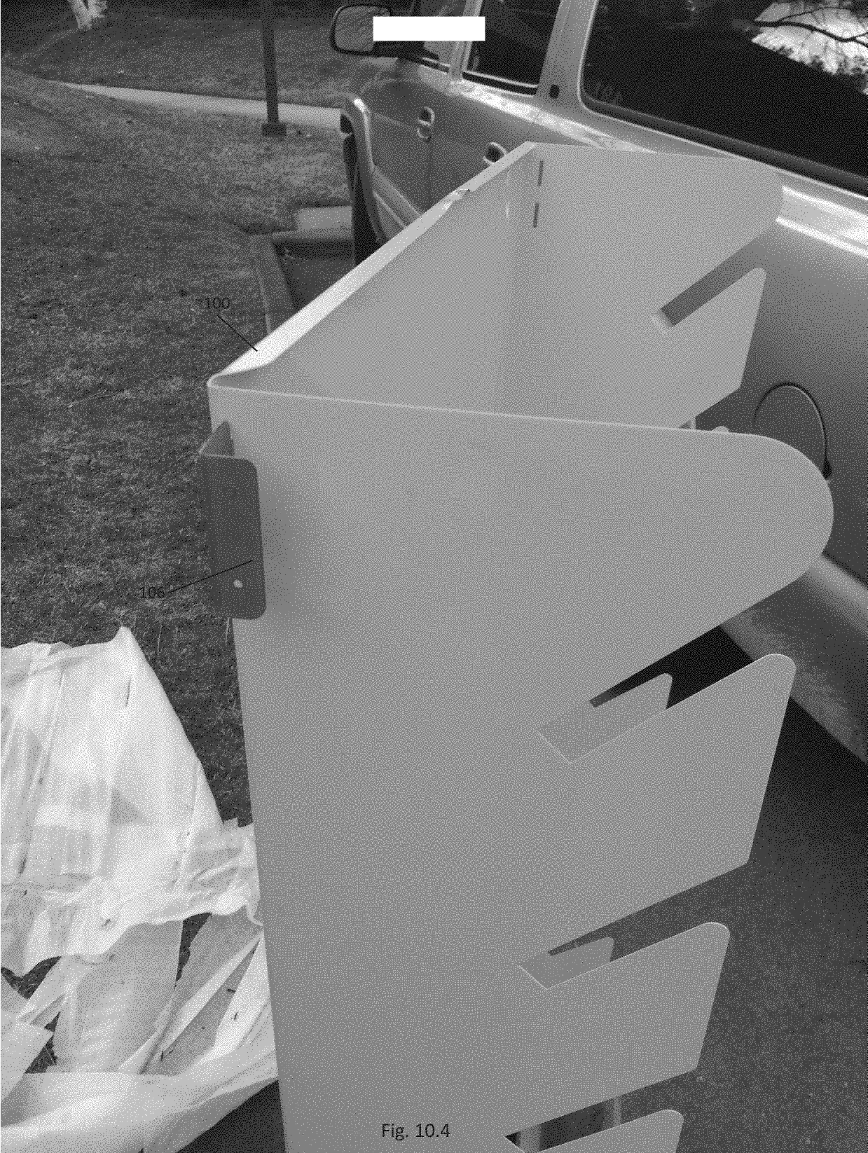

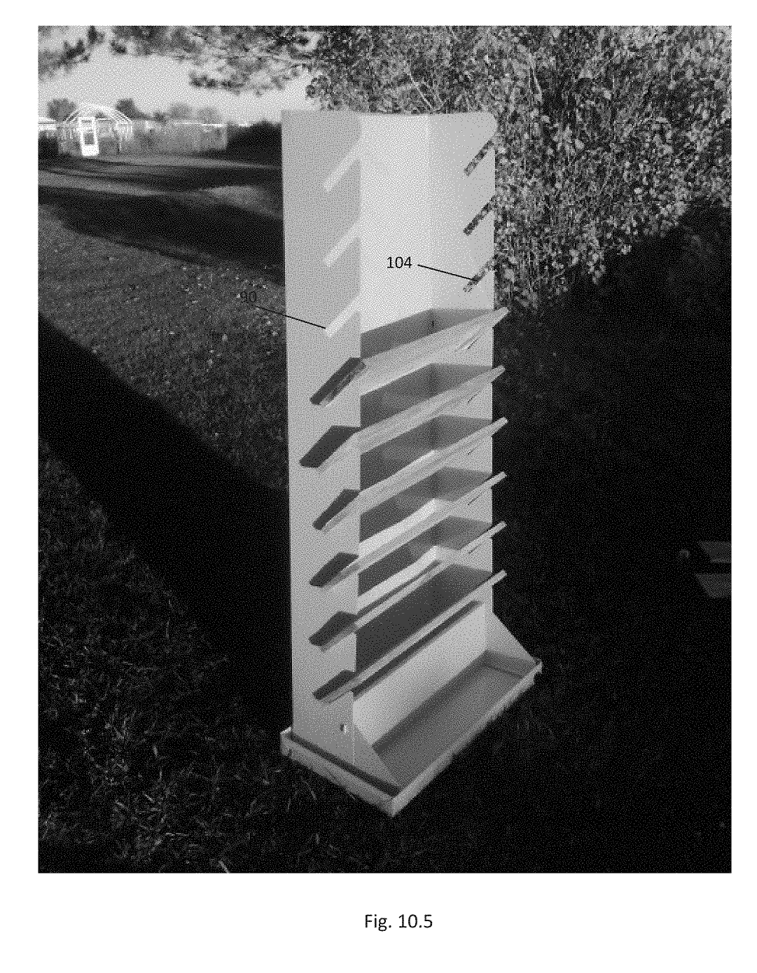

As illustrated in FIG. 10.5, channels or grooves are cut or formed in the sides of the vertical planter support 104, 90 such that the shelves extend between the sides with some overlap. The channels are located into the sides and provided at an angle so as to provide pockets formed by the board along with the sides. The channels are cut or formed a sufficient distance from the back section so as to leave a vertical channel extending the height of the planter which allows material poured in from the top of the planter to progressively fill up each of the channels from above.

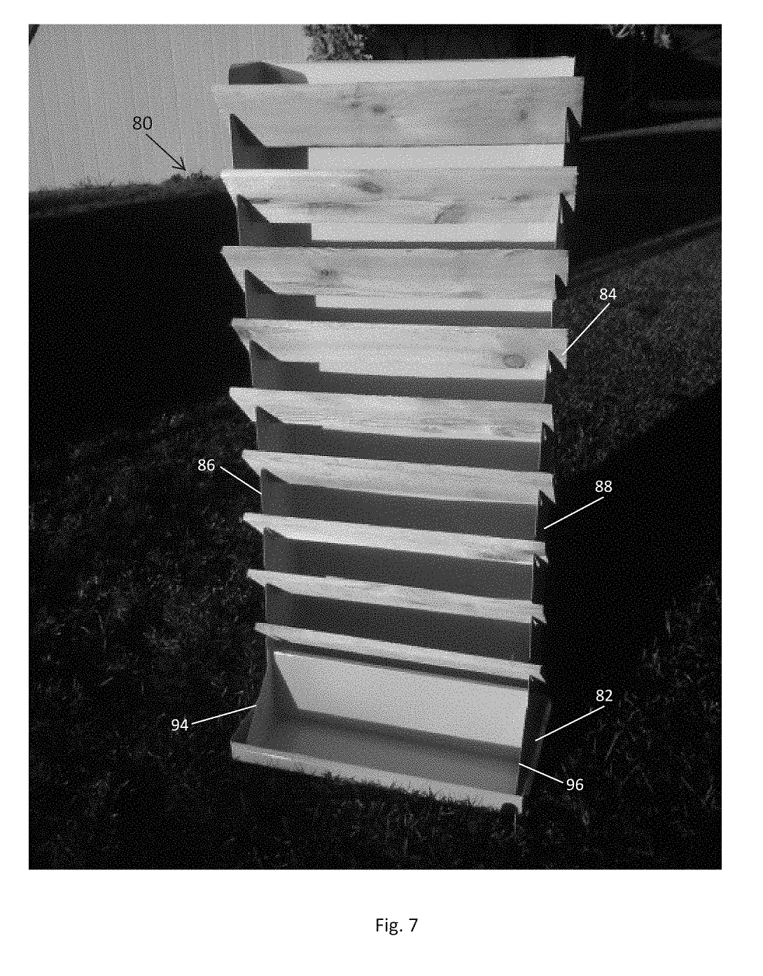

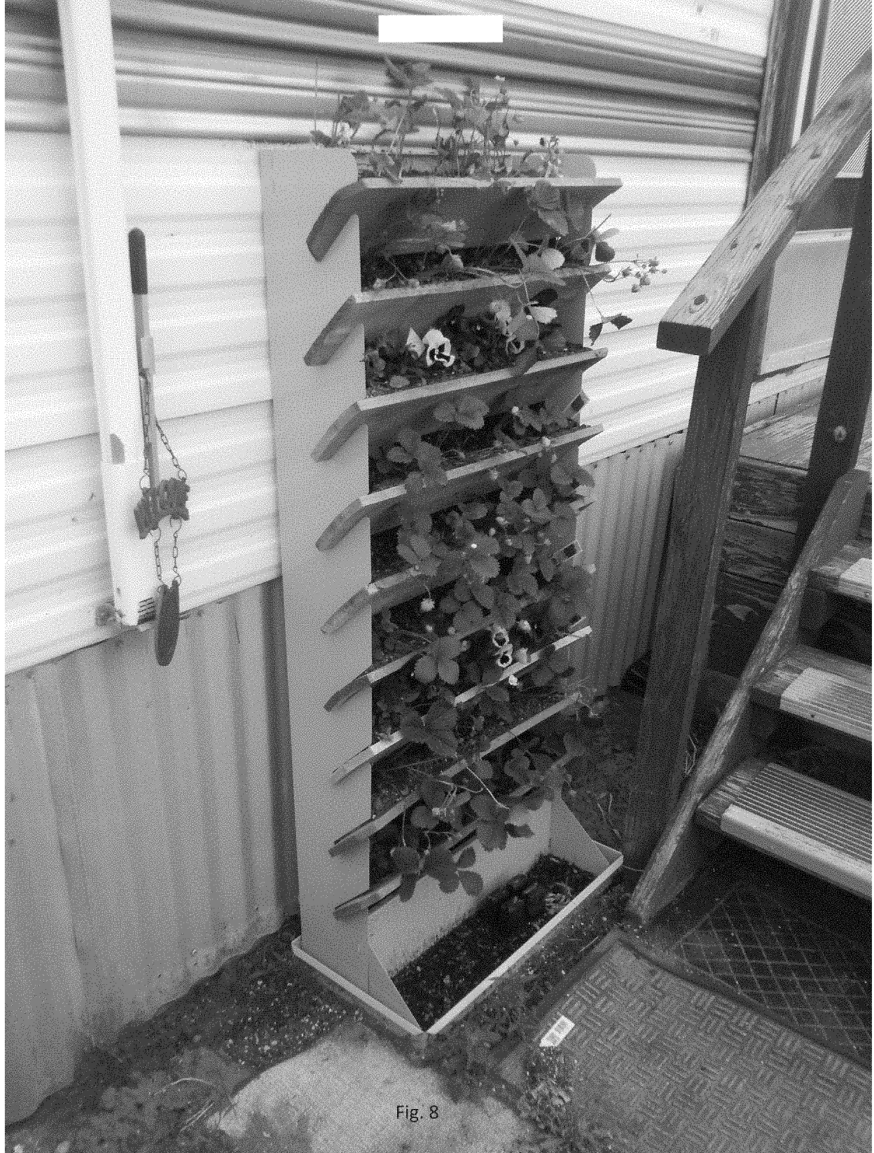

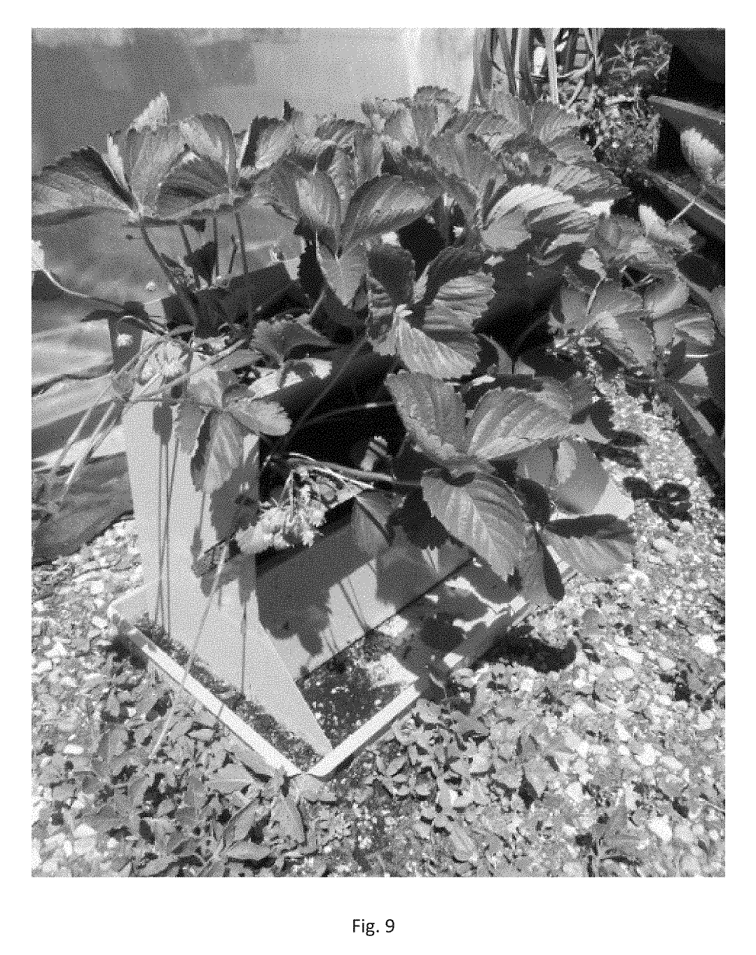

The sides of the vertical planter are supported by two feet 94, 96 that provide structural support. The vertical planter can be provided in a wide variety of heights including a taller vertical planter as shown in FIG. 8 or a shorter vertical planter as shown in FIG. 9. The vertical planner typically does not include the space saving cube or box insert of the cube planter depicted in 1 through 6.6 and instead provides for a root zone by providing space that is filled with soil between the shelves and the back section in the channel that extends the height of the planter.

FIGS. 10.1-10.5 illustrate the assembly steps of the vertical planter of FIG. 7. In a preferred embodiment, first the drip pan is assembled similar to the mechanism of the assembly of the drip pan for the cube disclosed in FIG. 1. Subsequently the two sides are positioned in the box supported by a cross member 92.

Feet are connected to each side of the vertical planter as illustrated in FIG. 10.2. A variety of connection mechanisms can be utilized to connect the feet the vertical sides. An integral connection mechanism 98 can be provided or alternatively the sides and back could be one piece that is folded or bent to form the connection shown in FIG. 10.4. Further, a mechanism 106 can be added to provide for a frame to support a greenhouse plastic cover or similar cover.

FIG. 10.3 illustrates the step of adding a horizontal structural piece 101 between the feet to provide the vertical structure with lateral stability. The size of the feet and drip pan are configured such that the feet fit within the drip pan.

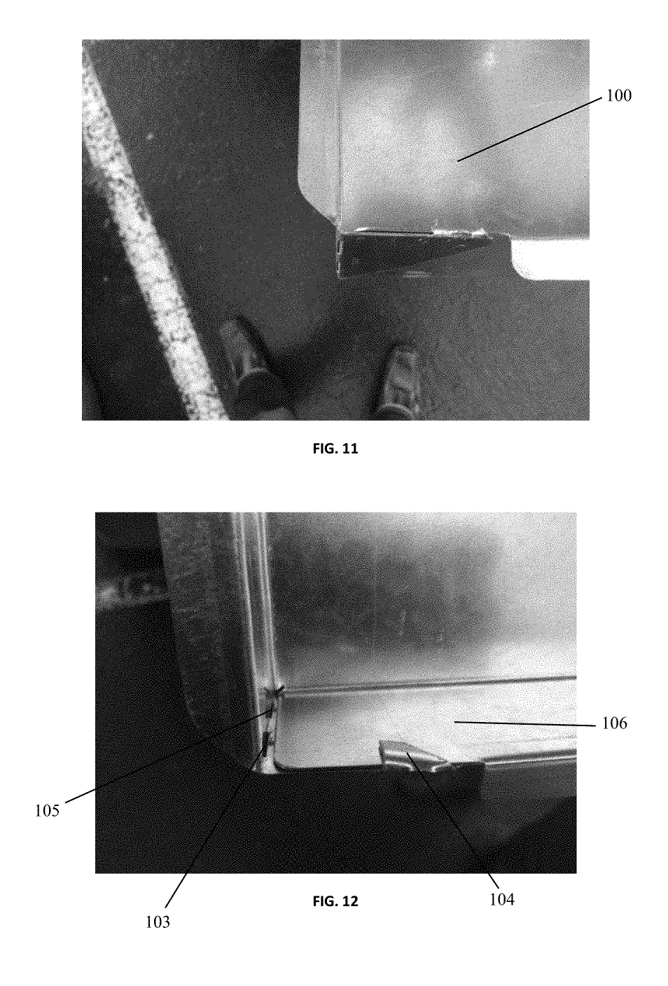

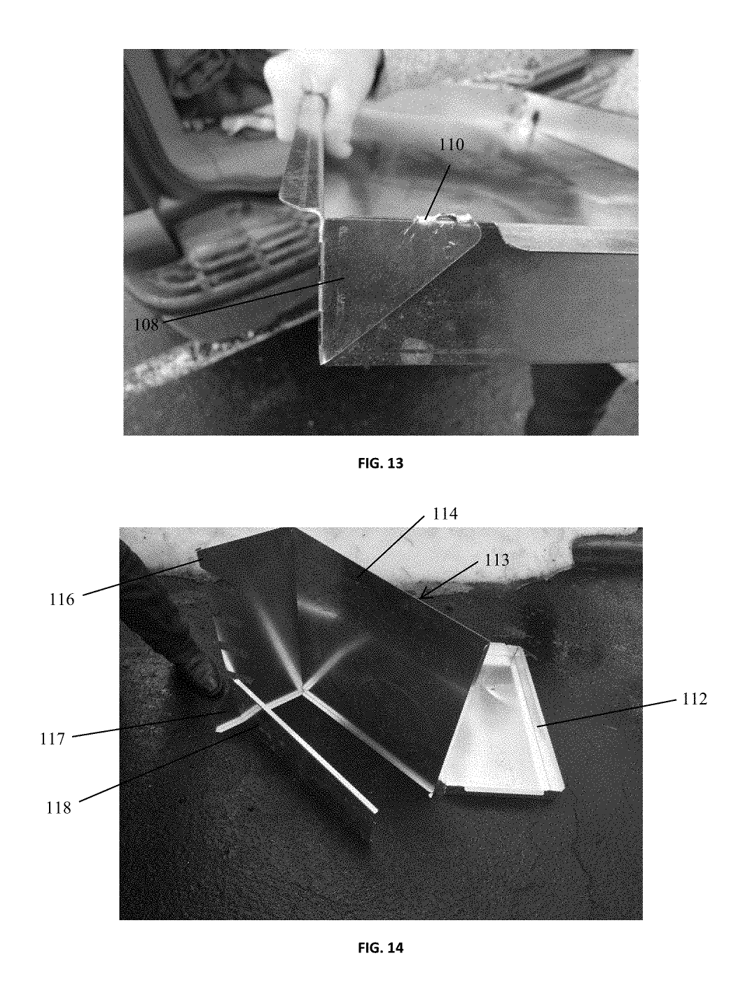

FIGS. 11-13 illustrate an embodiment of a drip pan 100 in which the sides of the drip pan are folded upward from a flat orientation. The sides are locked together by a combination of tab-slot mechanisms 102, 103, 105 and folded corners in which a corner tab 104 is folded over a side wall 106. The corner tab is attached to a corner 108 that folds around a side of the drip pan as shown in FIG. 13. The interior side of the drip pan interlocks with the tab-slot mechanism of FIG. 12.

FIG. 14 illustrates the assembly of a vertical section 112 of a planter, or alternatively the first vertical section of a modular planter. In a preferred embodiment, a side 116 is attached to the back 114 of the embodiment using the tab and slot mechanism detailed above. A horizontal stabilizer 117 or bottom section 118 is utilized to provide lateral stability and as a stop to soil falling out of the planter. The vertical section is configured for placement in the drip pan 112. A foot section 117 can be added to or integral with the side.

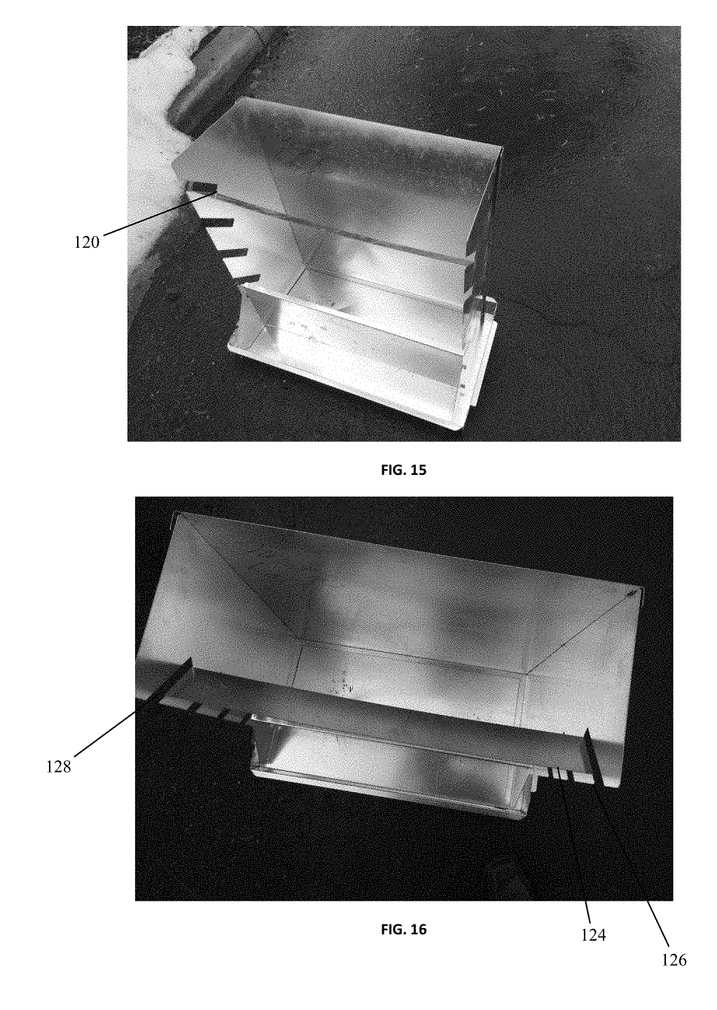

FIG. 15 illustrates a horizontal stabilizer 120 shown in a top slot position of a vertical section of the planter. FIG. 16 illustrates a top view of the planter shown in FIG. 15 illustrating the stabilizer piece of member 124 shown in a top slot position spanning between upper slots 126, 128.

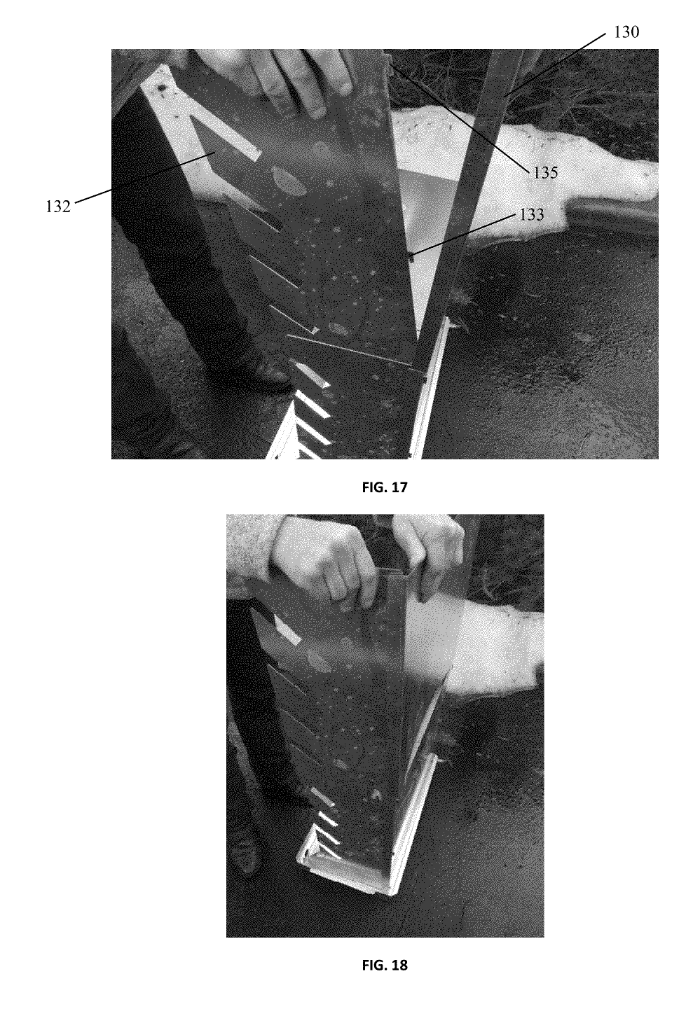

FIG. 17 illustrates a step in the process of adding a second modular vertical component to the top of the first vertical unit. A back 130 is placed on top of the back of the first vertical unit. Tabs 133, 135 attached to the sided are configured to insert into and be retained by slots (not shown) in the back 130. FIG. 18 illustrates the attaching of the side piece and back piece of FIG. 17 to the back via the tab and slot mechanism.

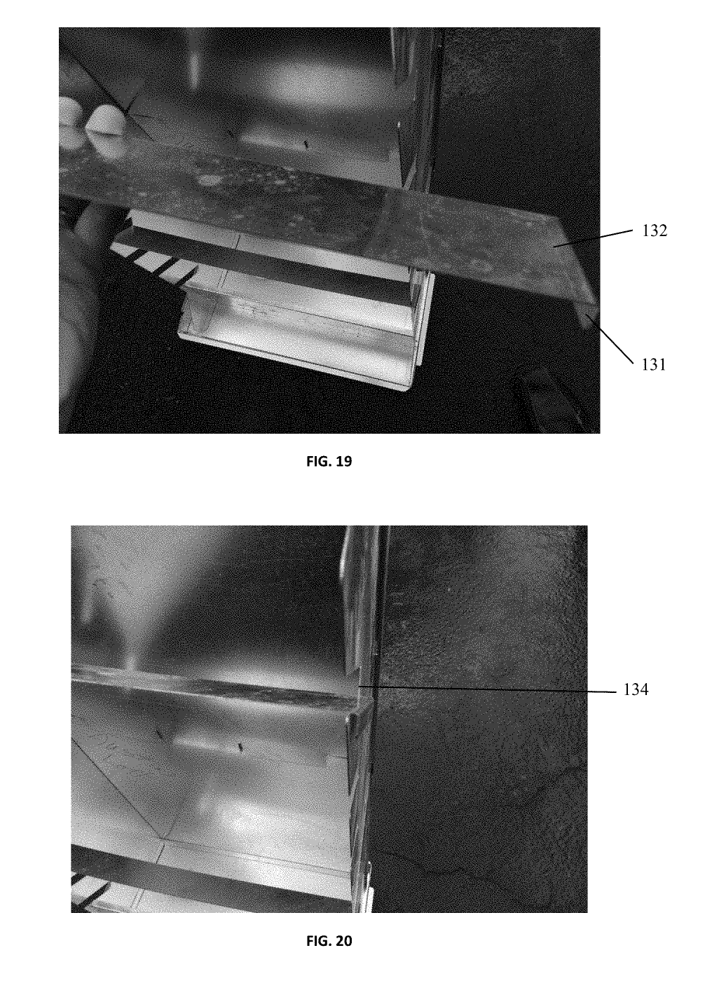

FIG. 19 illustrates a lateral stabilizer piece utilized to stabilize the upper vertical section. The lateral stabilizer is configured to span between two slots of the opposing sides of the vertical member as shown in FIG. 20. In a preferred embodiment the lateral stabilizer has flanges 131 that overlay the edges of each slot, e.g., 134, in the vertical side pieces.

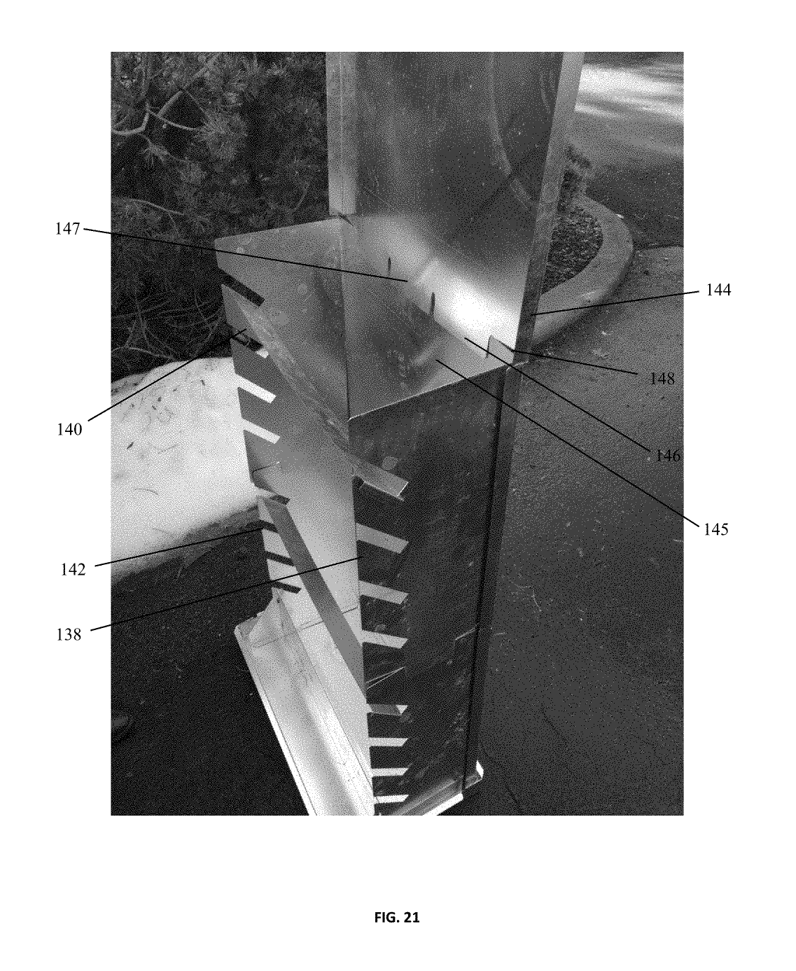

FIG. 21 illustrates a third vertical section being attached to a second vertical section. The back 144 of the third vertical section is being attached to the back 145 of the second vertical section. Tabs 146, 147 are positioned on one side of the back while another tab, not shown, is positioned on the opposite side of the back, as shown at 148. This effectively “locks” the back pieces together. A similar “interlacing tab” system is shown on the side pieces between the first and second vertical sections. Lateral stabilizer 140 is shown spanning between side pieces 142, 140.

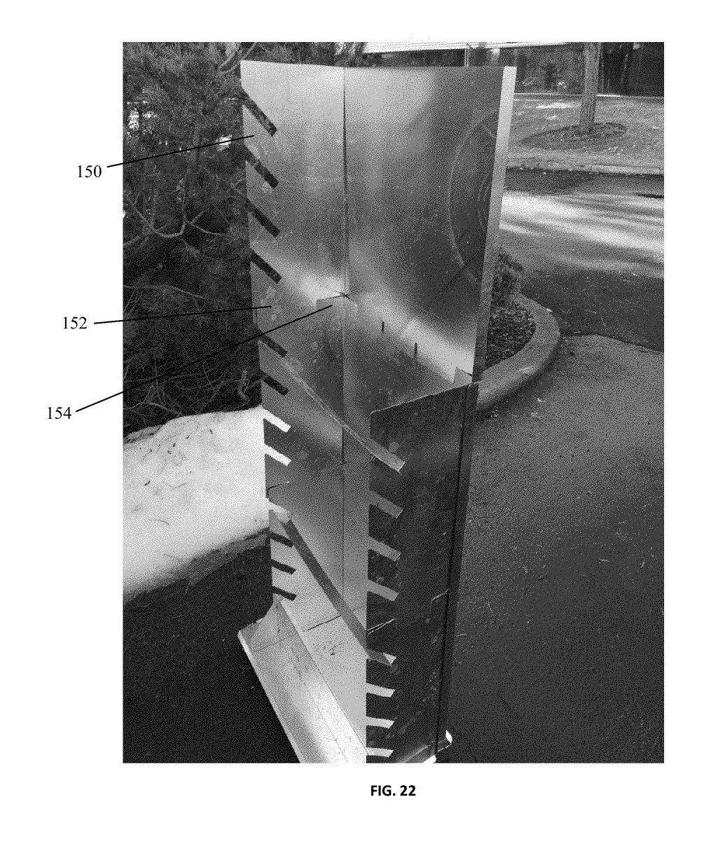

FIG. 22 illustrates a side piece 150 of the third vertical section being added to the side piece of the second vertical section. Alternating tabs 154, 152 operate to connect the side pieces of the vertically adjacent sections together.

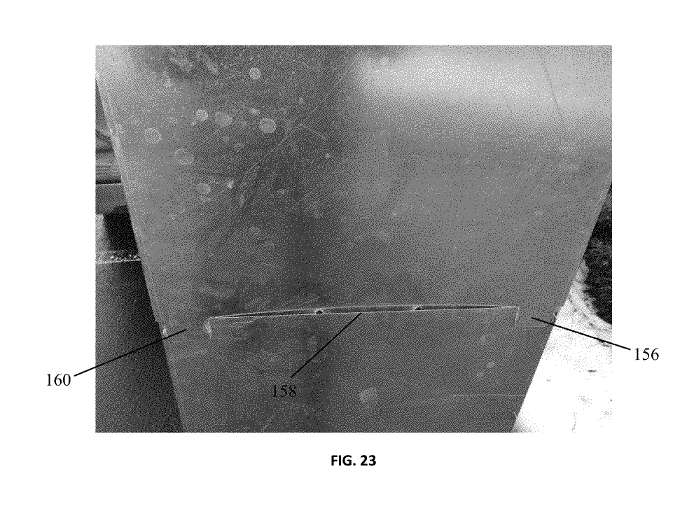

FIG. 23 illustrates a back view of a preferred embodiment as shown in FIG. 21 for attaching the back pieces of adjacent vertical sections. Tabs 160, 150 are on opposite sides of the back of the lower section to the tabs 146, 147 of tabs of the upper section. This view is of the same embodiment as that shown in FIG. 21.

While the depicted embodiments utilize wooden shelves and the remaining structural features are metal, the invention can be made in part or wholly of plastic, including but not limited to the process of injection molded plastic.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

I claim:

1. A collapsible space saving planter, wherein said planter comprises:
a first vertical support and a second vertical support generally located in a first plane;
a plurality of shelf members, wherein said shelf members span between said first vertical support and said second vertical support and are positioned in angled channels in said vertical supports to provide a series of angled shelves;
at least one horizontal support member connecting said first vertical support and said second vertical support;
a drip pan, wherein said drip pan is configured to hold a liquid, wherein said drip pan is configured such that said feet fit within said drip pan when connected to said first and second vertical supports;
wherein said vertical supports and said horizontal support are configured in relation to said shelves to provide for a void configured for plant growth medium to form a root growth zone behind said shelves such that a continuous section of plant growth medium can be provided extending behind said shelves; and
wherein said space saving planter is collapsible into a flat pack configuration.

2. The space saving planter of claim 1, wherein said space saving planter comprises four vertical supports connected by four horizontal support members and arranged in a cube, wherein said plurality of shelf members span between said vertical supports to provide a series of angled shelves between each of said vertical supports, wherein said shelf members and are positioned in angled channels in said vertical supports to provide said series of angled shelves, wherein said angled shelves are configured to retain a plant growth median.

3. The space saving planter of claim 2, wherein said space saving planter comprises an internal box, wherein said internal box is positioned within said cube.

4. The space saving planter of claim 1, wherein said space saving planter comprises at least two feet, wherein a foot is connected to a bottom of said first vertical support and a foot is connected to a bottom of said second vertical support, wherein said feet are configured to provide lateral support in a generally perpendicular direction to said horizontal support members.

5. The space saving planter of claim 1, wherein said space saving planter comprises a mounting system for an irrigation system.

6. The space saving planter of claim 1, wherein said space saving planter comprises a mounting system for a greenhouse cover.

7. The space saving planter of claim 3, wherein said internal box comprise a mounting system for a heating element.
